(19) United States
(12) Patent Application Publication
(10) Pub. No.: US 2006/0146970 A1
(43) Pub. Date: Jul. 6, 2006

(54) Start-stop synchronization serial communication circuit and semiconductor integrated circuit having start-stop synchronization serial communication circuit

(76) Inventors: Isami Kato, Handa (JP); Hiroshi Miyagi, Yokohama (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/544,054

(22) PCT Filed: Jan. 30, 2004
(86) PCT No.: PCT/JP04/00909

§ 371 Date: Jul. 29, 2005

(30) Foreign Application Priority Data
Jan. 31, 2003 (JP) 2003-023662

(51) Int. Cl. H04L 25/38

(52) U.S. Cl. 375/369

(57) ABSTRACT

When detecting a start bit, a start bit detection circuit 15a outputs a signal for starting the oscillating operation of a clock signal generation circuit 16. When latching an end code for indicating the end of serial communication, a latch circuit 21 outputs the end code to a decoder 26. The decoder 26 decodes the end code and outputs a signal for stopping the oscillating operation of the clock signal generation circuit 16. Thus, the power consumption of the clock signal generation circuit 16 can be reduced.

### TECHNICAL FIELD

The present invention relates to a start-stop synchronization type serial communication circuit and a semiconductor integrated circuit comprising a start-stop synchronization type serial communication circuit.

### BACKGROUND ART

A universal asynchronous receiver-transmitter (UART) for receiving start-stop synchronization serial data and converting it into parallel data, and also converting parallel data into serial data and transmitting it is known.

For example, Japanese Patent Application No. 2002-1688853 (Patent reference 1) discloses a technology for reducing data loss even when a data transmission speed is changed by a large amount in a start-stop synchronization type serial data transfer device.

This invention can recognize the transfer speed of serial data by measuring the bit width of a start bit, using a received clock and accurately receive serial data by frequency-dividing the received clock at a frequency division value corresponding to the recognized transfer speed.

Patent reference 1:

Japanese Patent Application No. 2001-168853 (Problems and Their Solutions in Abstract)

A start-stop synchronization type serial communication circuit comprises a clock signal generation circuit for generating a clock signal according to the transfer speed of serial data, and it is desired to reduce the power consumption of this clock signal generation circuit. For that purpose, when there is no transmission/reception of serial data, the oscillation frequency of the clock signal generation circuit is lowered and its power consumption is reduced. However, it is difficult to greatly reduce the power consumption by lowering the oscillating frequency.

### DISCLOSURE OF INVENTION

It is an object of the present invention to reduce the power consumption of the clock signal generation circuit of a start-stop synchronization type communication circuit.

The start-stop synchronization type communication circuit of the present invention comprises a conversion circuit for receiving serial data output from an external processor and converting it into parallel data, a clock signal generation circuit for supplying the conversion circuit with a clock signal, a detection circuit for detecting an end code for instructing the clock signal generation circuit to stop its oscillating operation of a clock signal transmitted from the processor and a control circuit for starting the oscillating operation of the clock signal generation circuit when detecting a start bit indicating the start of transmission of serial data, and stopping the oscillating operation of the clock signal generation circuit when detecting the end code by the detection circuit.

According to the present invention, when serial communication is started, the oscillating operation of the clock signal generation circuit can be started, and when receiving an end code, the oscillating operation of the clock signal generation circuit can be stopped. Therefore, the power consumption of the clock signal generation circuit can be reduced. In particular, when a serial communication circuit is installed in a semiconductor integrated circuit the power consumption of the semiconductor integrated circuit can be reduced.

In the present invention, the detection circuit comprises a latch circuit for latching an end code address-specified by address data output from the processor and transmitted following the address data or together with the address data.

By transmitting address data specifying the address of the latch circuit and end data from the processor in such a configuration the oscillating operation of the clock signal generation circuit can be stopped and its power consumption can be reduced. In the present invention, the detection circuit detects address data output from the processor as the end code. When the detection circuit detects the address data, the control circuit stops the oscillation operation of the clock signal generation circuit. For example, alternatively, when the processor outputs the end code as a specific address instead of data and the receiver side detects the specific address, the oscillation operation of the clock signal generation circuit can be stopped.

If the processor outputs address data as the end code in such a configuration, the oscillating operation can be stopped. In this case, since it is sufficient to detect address data only, no circuit for latching data is needed.

In the present invention, the detection circuit comprises a decoder for decoding the end code output from the processor and stopping the oscillating operation of the clock signal generation circuit.

If the processor transmits an end code indicating the end of transmission and the receiver side decodes the end code in such a configuration, the oscillating operation of the clock signal generation circuit can be stopped and its power consumption can be reduced.

For example, the processor corresponds to the central processing unit (CPU) 12 shown in FIG. 1, and the conversion circuit corresponds to the transmitting/receiving circuit 15 shown in FIG. 1. The clock signal generation circuit corresponds to the clock signal generation circuit shown in FIG. 1, and the detection circuit corresponds to the latch circuit 21 and decoder 26, shown in FIG. 1. The control circuit corresponds to the RS flip-flop 24 shown in FIG. 1.

### BRIEF DESCRIPTION OF DRAWINGS

FIG. 1 shows the major part of the receiving circuit of the first preferred embodiment.

FIGS. 2 (A) and (B) are examples of the data structure.

FIG. 3 shows a detailed circuit diagram of the receiving circuit.

FIG. 4 is the operational timing chart of the receiving circuit.

FIG. 5 shows the major parts of the receiving circuit of the second preferred embodiment.

### BEST MODE FOR CARRYING OUT THE INVENTION

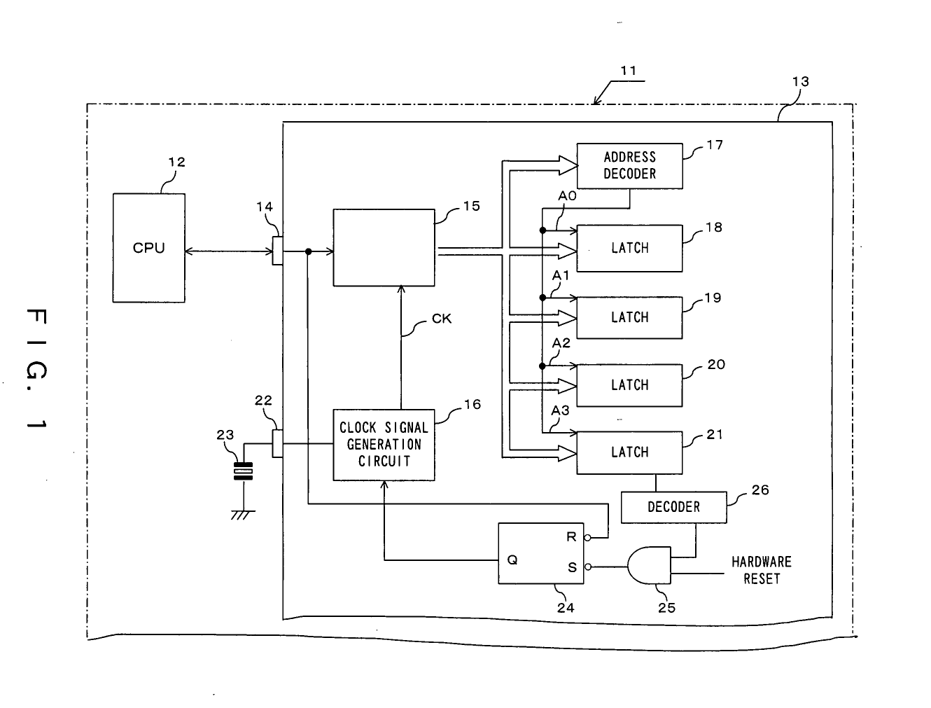

The preferred embodiments of the present invention are described below with reference to the drawings. FIG. 1 shows the major part of the receiving circuit of the FM/AM receiver in the first preferred embodiment of the present invention.

A receiving circuit 11 comprises a CPU 12, and a semiconductor integrated-circuit 13 provided with an FM/AM receiving circuit and a serial communication circuit. The CPU 12 and semiconductor integrated circuit 13 are mounted on the same printed wire board. The semiconductor integrated circuit 13 is manufactured by complementary metal-oxide semiconductor (CMOS) processing, and the FM/AM receiving circuit and serial communication circuit inside it are composed of metal-oxide semiconductor field-effect transistors (MOSFET).

In FIG. 1, serial data output by the CPU 12 is input to a transmitting/receiving circuit 14 composed of a universal asynchronous receiver-transmitter (UART) and the like via a serial port 14. The transmitting/receiving circuit 15 corresponds to a conversion circuit.

The transmitting/receiving circuit 15 comprises, for example, a 10-bit receiving shift register, a latch circuit, a receiving timing control circuit, a transmitting timing control circuit and the like. The transmitting/receiving circuit 15 sequentially shifts serial data synchronously with a clock signal CK, output by a clock signal generation circuit 16 and stores the data. The stored 8-bit data is output as parallel data.

The transmitting/receiving circuit 15 also converts the detected data of the receiving electric field intensity in the case of automatic channel selection output by an FM/AM receiving circuit, which is not shown in FIG. 1, and the like into serial data and outputs it to the CPU 12.

In this preferred embodiment, stop-start synchronization type serial communication is conducted between the CPU 12 and the semiconductor integrated circuit 13. In this case, serial data is transmitted in units of a character with a prescribed data length, for example, 8-bit character units, and a start bit and a stop bit are inserted into the head and end of the character, respectively. Furthermore, firstly, address data for specifying the output destination of data is output using four bits out of the eight bits and then another eights bits of data is output.

The clock signal generation circuit 16 supplies the transmitting/receiving circuit 15 with a clock signal CK obtained by frequency-dividing a signal generated by a crystal oscillator connected to its input terminal 22.

An address decoder 17 decodes parallel data output by the transmitting/receiving circuit 15. If the decoded result coincides with an address allocated to latch circuits 18˜21, the address decoder 17 outputs address selection signals A0˜A3 for enabling the corresponding latch circuits 18˜21.

Each of the latch circuits 18˜20 latches data for setting the reference frequency of a local oscillator circuit, which is not shown in FIG. 1, data for setting the frequency of a broadcast station or the like, and outputs the latched data to its corresponding circuit.

The latch circuit 21 latches an end code for stopping the oscillating operation of the clock signal generation circuit 16. When the address selection signal A3 is enabled, the latch circuit 21 latches parallel data output by the transmitting/receiving circuit 15, that is, an end code indicating the end of transmission, and outputs the latched end code to a decoder 26.

The decoder 26 decodes the end code and outputs a low level signal to one input terminal of an AND circuit 25.

To the other input terminal of the AND circuit 25, a hardware reset signal is input, and the output of the AND circuit 25 is output to the set terminal S of an RS flip-flop 24. The hardware reset signal is usually at a high level, and when the hardware is reset, it assumes a low level.

To the reset terminal R and set terminal S of the RS flip-flop 24, serial data and the output of the AND circuit 25 are input respectively, and the Q output is output to the clock signal generation circuit 16. In the RS flip-flop 24, the Q output is initially set at a low level.

When the CPU 12 outputs a start bit, the RS flip-flop 24 outputs a high level signal and starts the oscillating operation of the clock signal generation circuit 16. When the CPU 12 and AND circuit 25 output an end code and a low level stop signal or hardware reset signal, the RS flip-flop 24 outputs a low level signal and stops the oscillating operation of the clock signal generation circuit 16.

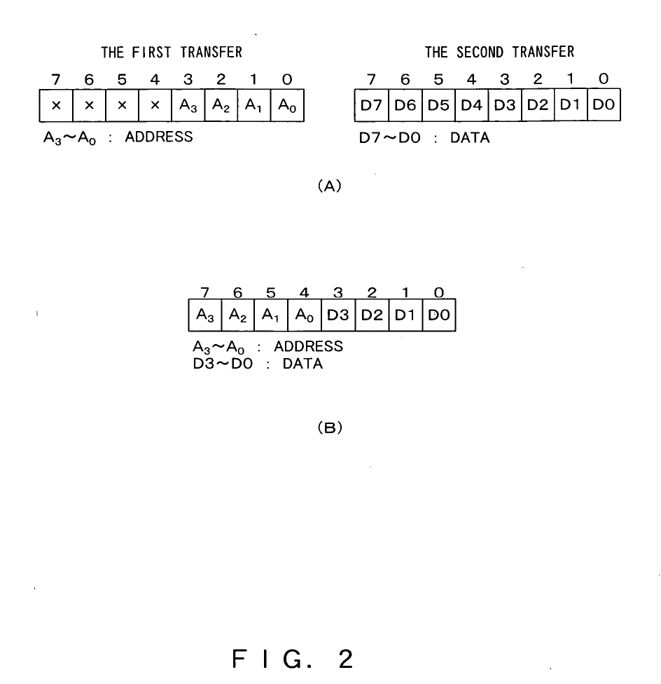

FIGS. 2 (A), (B) show examples of the structure of serial data output by the CPU 12.

FIG. 2(A) shows the data structure in the case where an address and data are transmitted using two bytes. In this case, firstly, four bits of an address are transmitted, and then, eight bits of data are transmitted. In this case, the four lower-order bits are used for address data. Then, an end code for stopping the operation of the clock signal generation circuit 16 is transmitted as data following the address.

FIG. 2(B) shows the data structure in the case where an address and data are transmitted using one byte. In this case, the four higher-order bits and the four lower-order bits are allocated to an address and data, respectively.

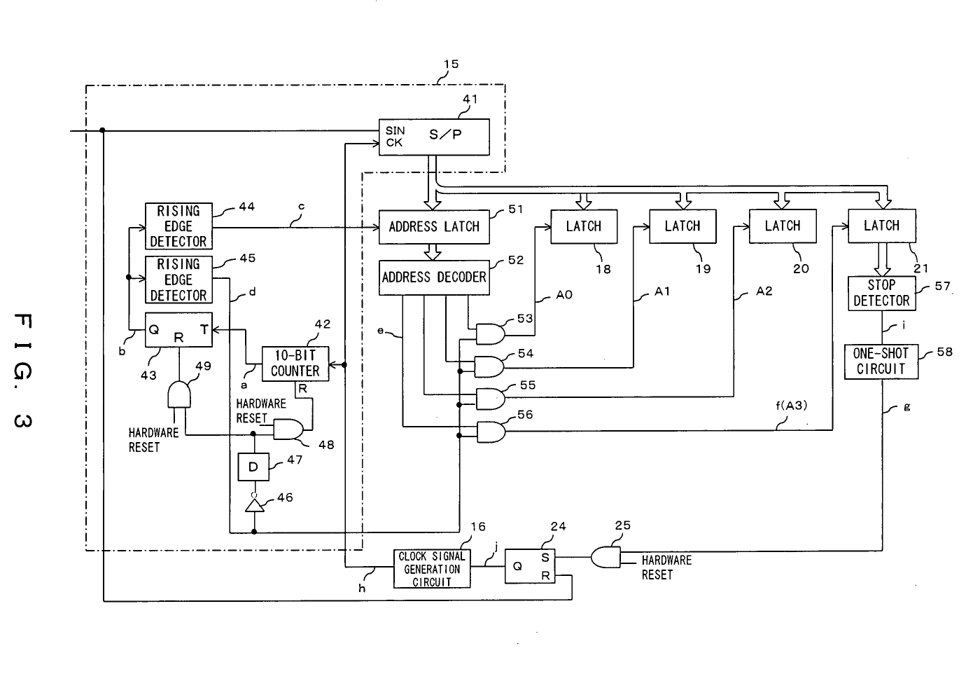

FIG. 3 shows the detailed circuit diagrams of the transmitting/receiving circuit 15 and address decoder 17 respectively, as shown in FIG. 1.

A serial/parallel conversion circuit 41 made up of 10 bits of shift register converts eight bits of serial data output by the CPU 12 into parallel data, and outputs the parallel data to an address latch circuit 51 and latch circuits 18˜21.

A 10-bit counter 42 counts clock signals output by the clock signal generation circuit 16. After counting ten clocks, the 10-bit counter 42 outputs a count-up signal “a” to a T flip-flop 43.

The T flip-flop 43 inverts the Q output by the count-up signal “a” of the 10-bit counter 42. The Q output signal “b” of this T flip-flop 43 is output to a rising edge detecting circuit 44 and a falling edge detecting circuit 45.

The rising edge detecting circuit 44 detects the rising edge of the Q output signal “b” of the T flip-flop 43, and outputs a high-level latch signal c with a specific width to an address latch circuit 51.

When the latch signal “c” assumes a high level, the address latch circuit 51 latches the eight bits of address data output by the serial/parallel conversion circuit 41.

The falling edge detecting circuit 45 detects the falling edge of the Q output signal “b” of the T flip-flop 43, and outputs a high level signal “d” with a specific width to an inverter 46 and AND gates 53˜56. After the output of the inverter 46 is output to a delay circuit 47 composed of a shift register and the like and a specific delay is applied to it, it is output to one input terminal of the AND gates 48 and 49. To the other input terminal of the AND gate 48, a hardware reset signal which is usually at a high level is input. The output of the AND gate 48 is input to the reset terminal of 10-bit counter 42. Similarly, to the other input terminal of the AND gate 49, a hardware reset signal is input.

When the hardware reset signal assumes a low level, by the inverter 46, delay circuit 47 and AND gates 48 and 49, or when the falling edge detecting circuit 45 detects the falling edge of the Q output signal “b” of the T flip-flop 43 and a specific delay time has elapsed, the 10-bit counter 42 and T flip-flop 43 are reset.

The address decoder 52 decodes the address data latched by the address latch circuit 51, and outputs a signal for specifying a corresponding latch circuit out of latch circuits 18˜21 to the AND gates 53˜56.

When the address decoder 52 outputs a high level signal and when the falling edge detecting circuit 45 output a high level detection signal “d”, each of the AND gates 53˜56 outputs selection signals A0˜A3 for selecting one of the latch circuits 18˜21.

The above-mentioned address latch circuit 51, address decoder 52 and AND gates 53˜56 correspond to the address decoder 17 shown in FIG. 1.

The stop detection circuit 57 outputs the result of decoding an end code output by the latch circuit 21 or data obtained by extracting a specific bit to a one-shot circuit 58. When the stop detection circuit 57 outputs a low level signal, the one-shot circuit 58 outputs a low level signal “g” with a specific width to the AND gate 25.

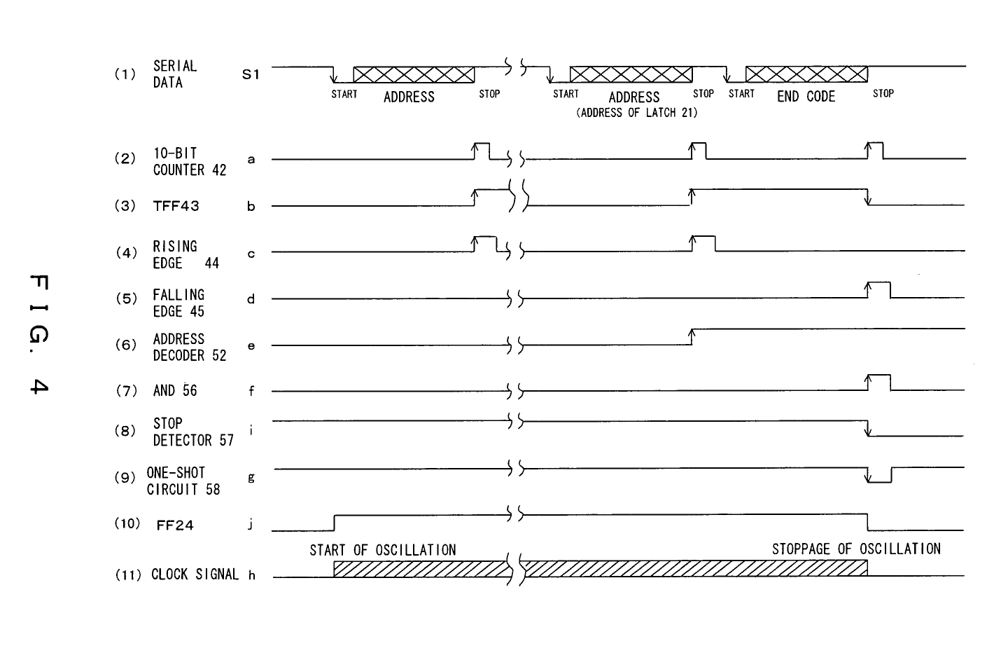

Next, the respective operations at the respective times of start and end of the serial communication of the receiving circuit with the above-mentioned configuration are described with reference to the timing chart shown in FIG. 4.

When serial communication is started, as shown in FIG. 4 (1), the CPU 12 outputs a start bit which assumes a low level for a specific period, eight bits of serial data and a stop bit which assumes a high level for a specific period.

When the low-level start bit is input to the reset terminal R of the RS flip-flop 24, the Q output signal assumes a high level. When the RS flip-flop 24 outputs a high level signal, as shown in FIG. 4 (10), the clock signal generation circuit 16 starts its oscillating operation.

After transmitting a start bit in notification of the start of data transmission, the CPU 12 transmits invalid data for a specific period if necessary until the clock signal generation circuit 16 oscillates stably, and then transmits valid serial data.

If ending data transmission or data reception, the CPU 12 transmits address data specifying the latch circuit 21 and an end code.

The 10-bit counter 42 counts clock signals output by the clock signal generation circuit 16. After counting ten clocks the 10-bit counter 42 outputs a count-up signal “a” with the timing as shown in FIG. 4(2).

As shown in FIG. 4 (3), just before the CPU 12 outputs address data for specifying the latch circuit 21, the T flip-flop 43 is reset, and the Q output signal “b” assumes a low level. When the CPU 12 outputs the address data for specifying the latch circuit 21 and the 10-bit counter 42 outputs the count-up signal “a”, the Q output signal “b” assumes a high level.

When the level of the Q output signal “b” changes from low to high, the rising edge detection circuit 44 detects the rising edge of the signal “b”, and as shown in FIG. 4 (4), outputs a rising edge detection signal “c” with a specific width. The address latch circuit 51 latches address data (address for specifying the latch circuit 21) output by the serial/parallel conversion circuit 41 in timing synchronous with the rising edge detection signal “c”. The address latched by the address latch circuit 51 is decoded by the address decoder 52 and a high level signal “e” for selecting the latch circuit 21 is output (FIG. 4 (6)).

Then, when receiving a stop bit following an end code after the CPU 12 outputs the end code, the 10-bit counter 42 outputs a count-up signal “a”.

When the 10-bit counter 42 outputs the count-up signal “a”, as shown in FIG. 4 (3), the level of the Q output signal “b” of the T flip-flop 43 changes from high to low. The rising edge detection circuit 45 detects this change of the Q output signal “b”, and as shown in FIG. 4 (5), the rising edge detection circuit 45 outputs a high level rising edge detection signal “d” with a specific width.

When the rising edge detection signal “d” assumes a high level, an AND gate 56, which the address decoder 52 outputs a high level signal “e” to, opens at this time and a high level selection signal “f” (A3) is output by the AND gate 56 to the latch circuit 21 (FIG. 4 (7)).

When the selection signal “f” is output by the AND gate 56, the latch circuit 21 latches an end code output by the serial/parallel conversion circuit 41. The stop detection circuit 57 decodes the end code latched by the latch circuit 21 and outputs a low level signal to the one-shot circuit 58 (FIG. 4 (8)). When the low level signal is input, the one-shot circuit 58 outputs a low level signal “g” with a specific width to the AND gate 25 (FIG. 4 (9)).

When the low level signal “g” is input to the AND gate 25, the set terminal S of the RS flip-flop 24 assumes a low level and the Q output signal assumes a low level. When the Q output signal of the RS flip-flop 24 assumes a low level, the clock signal generation circuit 16 stops the oscillating operation (FIG. 4 (10)).

According to the above-mentioned preferred embodiment, when a start bit is output, the oscillation operation of the clock signal generation circuit 16 is started. When an end code for instructing the clock signal generation circuit 16 to stop the oscillating operation, output from the CPU 12 is detected, the oscillating operation of the clock signal generation circuit 16 is stopped. Thus, when no data is transmitted/received, the oscillating operation of the clock signal generation circuit 16 can be completely stopped. Therefore, the power consumption of the clock signal generation circuit 16 can be reduced.

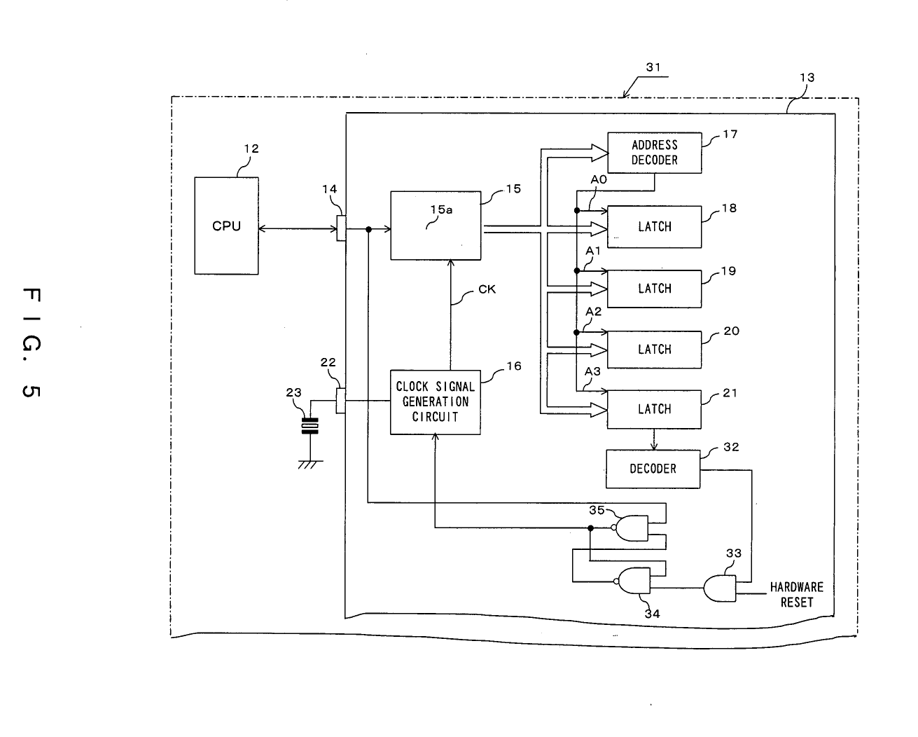

Next, FIG. 5 shows the major parts of the receiving circuit 31 in the second preferred embodiment of the present invention. In FIG. 5, the same reference numerals are attached to the circuit blocks that are the same as those in FIG. 1, and their descriptions are omitted.

In FIG. 5, a decoder 32 decodes data latched by the latch circuit 21, and the decoded result is output to one input terminal of an AND circuit 33. To the other input terminal of the AND circuit 33, a hardware reset signal is input, and the output of the AND circuit 33 is input to one input terminal of a NAND circuit 34.

To one input terminal of a NAND circuit 35, a start bit output from the CPU 12 is input, and to the other input terminal, the output of the NAND circuit 34 is input. The output of the NAND circuit 35 is input to the clock signal generation circuit 16 and the other input terminal of the NAND circuit 34.

The respective operations of the above-mentioned circuits are described below. Initially, the output of the NAND circuit 35 is set at a low level, and the clock signal generation circuit 16 stops the oscillating operation.

When the CPU 12 outputs a start bit and the input of the NAND circuit 35 assumes a low level, the output assumes a high level. Then, a high-level control signal is output to the clock signal generation circuit 16, and the clock signal generation circuit 16 starts its oscillating operation.

When the transmission or reception of data is ended, the CPU 12 transmits an end code as eight bits of data.

When the address decoder 17 outputs an address selection signal A3, the latch circuit 21 latches an end code subsequently output by the transmitting/receiving circuit 15. The decoder 32 decodes the latched data and outputs one bit of low level data to the AND circuit 33.

When the input of the AND circuit 33 assumes a low level, a low level signal is output to the NAND circuit 34, and the NAND circuit 34 assumes a high level. After the detection of the start bit is completed, the output of a start bit detection circuit 15a is switched over to a high level and both inputs of the NAND circuit 35 assume high levels. The control signal output by the NAND circuit 35 to the clock signal generation circuit 16 assumes a low level. As a result, the clock signal generation circuit stops the oscillating operation.

According to the second preferred embodiment, the oscillation operation of the clock signal generation circuit 16 for generating communication clock signals can be performed. Otherwise, the oscillating operation of the clock signal generation circuit 16 can be stopped. Therefore, the power consumption of the clock signal generation circuit 16 can be reduced.

Next, the third preferred embodiment of the present invention is described. This third preferred embodiment can be achieved by collecting in one circuit block a control circuit comprising an end code detection circuit for detecting an end code for instructing the clock signal generation circuit 16 to stop its oscillating operation (corresponding to the latch circuit 21 shown in FIG. 1) and a circuit for starting or stopping the oscillating operation of the clock signal generation circuit 16, based on the start bit and the detection signal of an end code detection circuit (corresponding to the RS flip-flop 24 shown in FIG. 1).

This third preferred embodiment can reduce the power consumption of the clock signal generation circuit 16 by operating the clock signal generation circuit only when transmitting/receiving serial data.

The configuration of the present invention is not limited to the above-mentioned preferred embodiments, and the present invention can also be configured as follows.

(a) The control circuit for controlling the oscillating operation of the clock signal generation circuit 16 is not limited to one using the latch circuit 21 and RS flip-flop 24 that are described in the preferred embodiments, and other circuits can also be used.

(b) The application target of the present invention is not limited to the receiving circuit of an FM/AM receiver and a semiconductor integrated circuit, and the present invention can also be applied to any circuit and any semiconductor integrated circuit as long as they have a serial communication circuit.

According to the present invention, since the oscillating operation of a clock signal generation circuit can be started when starting serial communication, and it can be stopped when ending the serial communication, the power consumption of the clock signal generation circuit can be reduced.

1. A start-stop synchronization type serial communication circuit, comprising:
a conversion circuit for receiving serial data output by an external processor and converting the data into parallel data;
a clock signal generation circuit for supplying the conversion circuit with clock signals;
a detection circuit for detecting an end code for the clock signal generation circuit to stop its oscillating operation which is transmitted from the processor; and
a control circuit for starting the oscillating operation of the clock signal generation circuit when detecting a start bit for indicating the start of transmission of the serial data and stopping the oscillating operation of the clock signal generation circuit when detecting the end code.

2. The start-stop synchronization type serial communication circuit according to claim 1, wherein
said detection circuit comprises a latch circuit for latching an end code whose address is specified by address data output by the processor and which is transmitted following or together with the address data.

3. The start-stop synchronization type serial communication circuit according to claim 1, wherein
said detection circuit detects the address data output by the processor as the end code, and
said control circuit stops the oscillating operation of said clock signal generation circuit when said detection circuit detects the address data.

4. The start-stop synchronization type serial communication circuit according to claim 1, wherein
said detection circuit comprises a decoder for decoding the end code output by the processor and outputting a signal for stopping the oscillating operation of said clock signal generation circuit.

5. A semiconductor integrated circuit which comprises a start-stop synchronization type serial communication circuit, said start-stop synchronization type serial communication circuit comprising:
a conversion circuit for receiving serial data output by an external processor and converting the data into parallel data;
a clock signal generation circuit for supplying the conversion circuit with clock signals;
a detection circuit for detecting an end code for the clock signal generation circuit to stop its oscillating operation which is transmitted from the processor; and
a control circuit for starting the oscillating operation of the clock signal generation circuit when detecting a start bit for indicating start of transmission of the serial data and stopping the oscillating operation of the clock signal generation circuit when detecting the end code.

6. The semiconductor integrated circuit comprising a start-stop synchronization type serial communication circuit, according to claim 5, wherein
said detection circuit comprises a latch circuit for latching an end code whose address is specified by address data output by the processor and which is transmitted following or together with the address data.
